(19) United States
(12) Patent Application Publication
(10) Pub. No.: US 2018/0062269 A1
(43) Pub. Date: Mar. 1, 2018

(54) ANTENNA APPARATUS

(71) Applicant: KABUSHIKI KAISHA TOSHIBA, Tokyo (JP)

(72) Inventors: Seiya KISHIMOTO, Tokyo (JP); Makoto HIGAKI, Tokyo (JP); Makoto SANO, Kawasaki Kanagawa (JP)

(73) Assignee: KABUSHIKI KAISHA TOSHIBA, Tokyo (JP)

(21) Appl. No.: 15/444,635

(22) Filed: Feb. 28, 2017

(30) Foreign Application Priority Data
Aug. 29, 2016 (JP) 2016-167048

(51) Int. Cl. H01Q 13/10; H01Q 3/24; H01Q 15/14

(52) U.S. Cl. CPC H01Q 13/10; H01Q 15/14; H01Q 3/24

(57) ABSTRACT

According to one embodiment, an antenna apparatus a substrate, a plurality of slot elements, a power feed line, and a plurality of switch elements. The substrate includes a first surface and a second surface that faces the first surface. The slot elements are provided on the first surface of the substrate. The power feed line is provided on the second surface of the substrate and feeds power to the slot elements. The switch elements switch between a short-circuit state and an open state of the respective slot elements.

### CROSS-REFERENCE TO RELATED APPLICATIONS

This application is based upon and claims the benefit of priority from Japanese Patent Application No. 2016-167048, filed Aug. 29, 2016, the entire contents of which are incorporated herein by reference.

### FIELD

Embodiments described herein relate generally to an antenna apparatus.

### BACKGROUND

As conventional antennas, a type of antenna that has two slots and two power feed lines to enable power-feeding with a phase difference to the slots is known. A power feeding target is switched between the slots by selecting one power feed line used when radio waves are radiated. As a result, antenna directivity can be controlled and changed.

The above-described antenna has the basic structure having the two slots and the two power feed lines. If the slots are increased to four, the basic structure of the antenna has four slots and four power feed lines. Therefore, even if the antenna has four slots, there are only four radiation patterns to be switched. In other words, the number of radiation patterns is the same as the number of slots. Thus, the number of feasible radiation patterns is inevitably limited to the number of slots.

### BRIEF DESCRIPTION OF THE DRAWINGS

FIG. 1 is a diagram showing an antenna apparatus according to a first embodiment.

FIG. 2A is a side view of an antenna portion.

FIG. 2B is a top view of the antenna portion.

FIG. 3 is a diagram showing an example of radiation patterns of the antenna apparatus according to the first embodiment.

FIG. 4 is a diagram showing an example of radiation patterns in which impedance matching should be taken into consideration.

FIG. 5 is a diagram showing a first modification of the antenna part.

FIG. 6 is a diagram showing a second modification of the antenna part.

FIG. 7 is a diagram showing an antenna apparatus according to a second embodiment.

### DETAILED DESCRIPTION

According to one embodiment, an antenna apparatus a substrate, a plurality of slot elements, a power feed line, and a plurality of switch elements. The substrate includes a first surface and a second surface that faces the first surface. The slot elements are provided on the first surface of the substrate. The power feed line is provided on the second surface of the substrate and feeds power to the slot elements. The switch elements switch between a short-circuit state and an open state of the respective slot elements.

Hereinafter, an antenna apparatus according to the embodiments will be described in details with reference to the drawings. In the following embodiments, like elements are denoted by like reference symbols, and redundant explanations thereof will be omitted as appropriate.

### First Embodiment

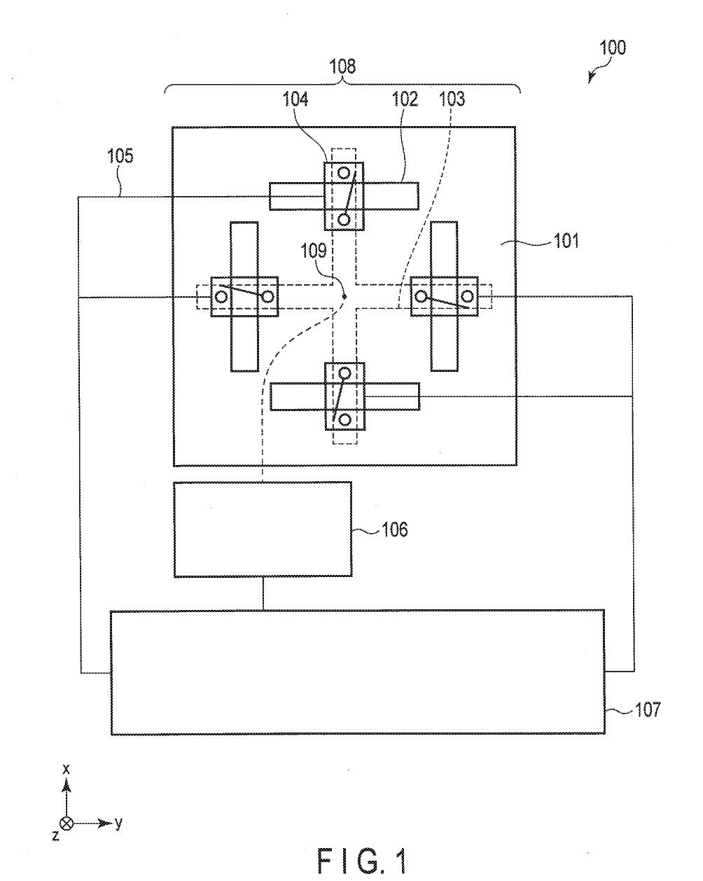

FIG. 1 schematically shows an antenna apparatus 100 according to the first embodiment. As shown in FIG. 1, the antenna apparatus 100 includes a substrate 101, a plurality of slot elements 102, a power feed line 103, a plurality of switch elements 104, a control line 105, a wireless part 106, and a controller 107.

The substrate 101, the slot elements 102, the power feed line 103, and the switch elements 104 are collectively referred. to as an antenna part 108.

The substrate 101 is, for example, a dielectric substrate. The substrate 101 may be a substrate generally used for producing an antenna. The substrate 101 includes a first surface and a second surface that faces the first surface. FIG. 1 is a top view showing the first surface of the substrate 101.

The slot elements 102 are formed on the first surface of the substrate 101. In this embodiment, it is assumed that an opening obtained by cutting off a part of a conductor layer provided on the first surface functions as a slot element. The slot elements 102 may be formed of a conductor on the first surface. The slot elements 102 may be arranged to be rotationally symmetric about a discretionary point (referred to as a first point 109) of the substrate 101 as viewed in a direction perpendicular to the first surface (z direction). In other words, the slot elements 102 may be arranged to be rotationally symmetric about an axis that is perpendicular to the first surface and passes through the first point 109. The shape of the slot element 102 is assumed to be rectangular in this embodiment, but it may be bent or curved. The slot element 102 preferably is of a shape that has a longer direction and a shorter direction and that can appropriately emit electromagnetic waves of a radio frequency range in use. If necessary, the slot element 102 may also be of a shape not having a longer direction or a shorter direction, such as a square or a circle (in which all sides are equally distant from the center of the slot element 102).

The power feed line 103 is arranged on the second surface of the substrate 101 facing the first surface, and feeds power to the slot elements 102. In the example shown in FIG. 1, the power feed line 103 is rotationally symmetric about the first point 109 of the substrate 101 as viewed in a direction perpendicular to the first surface (or the second surface). In other words, the power feed line 103 is rotationally symmetric about the described-above axis. The power feed line 103 linearly extends from the first point 109 to positions where power can be supplied to the slot elements 102. The power feed line 103 may be curved or may have any other shape that can feed power to the slot elements 102.

The switch elements 104 are arranged on the substrate 101 to be paired with the respective slot elements 102. The switch elements 104 switch between a short-circuit state and an open state of the respective slot elements 102. The switch elements 104 are switched between ON and OFF states by a control signal supplied from the controller 107 to short-circuit or open the slot elements 102 in the shorter direction (across the two long sides in the example of FIG. 1). When the switch element 104 is in the ON state, the slot element 102 is short-circuited in the shorter direction. When the switch element 104 is in the OFF state, the slot element 102 is open, that is, operation of the slot element 102 is not affected. The switch elements 104 may be arranged on either the first surface or the second surface, or an interlayer of the substrate 101; they may he arranged in any positions that can short-circuit or open the slot elements 102 in the shorter direction. If the slot element 102 is of a shape not having a longer direction or a shorter direction, such as a square or a circle, the switch element 104 may be arranged to switch between ON and OFF states so that phases can be different in a short-circuited state and an open state of the slot element 102.

The portion of the slot element 102 that is short-circuited by the switch element 104 is assumed to be, but is not limited to, a central portion of the longer sides. The switch element 104 may be any element that can short-circuit or open the slot element 102 in a radio frequency range in use; for example, it may be a semiconductor element such as a PIN diode, a micro electro mechanical system (MEMS), or an element having a function to vary an impedance.

The control line 105 is electrically connected to the switch elements 104, and transmits a control signal from the controller 107 to the switch elements 104.

The wireless part 106 acquires a propagation status of a wireless signal transmitted to and received through the slot elements 102 from the antenna part 108. The propagation status may be indicated by using an indicator, for example, a received signal strength indicator (RSSI) or an error vector magnitude (EVM). The indicator is not limited to the above; the indicator may be anything that can indicate a propagation status.

The controller 107 is electrically connected to the switch elements 104 through the control line 105. The controller 107 receives the propagation status from the wireless part 106, controls the switch element 104 based on the propagation status, and generates a control signal to short-circuit or open the slot element 102. For example, if the propagation status is a value lower than a threshold, the controller 107 controls the switch element 104 to switch to a radiation pattern to increase the value of the propagation status to the threshold or higher. Although the wireless part 106 and the controller 107 are depicted as being located on an xy plane for convenience in explanation, they may be located in any positions as long as they are connected to the antenna part 108.

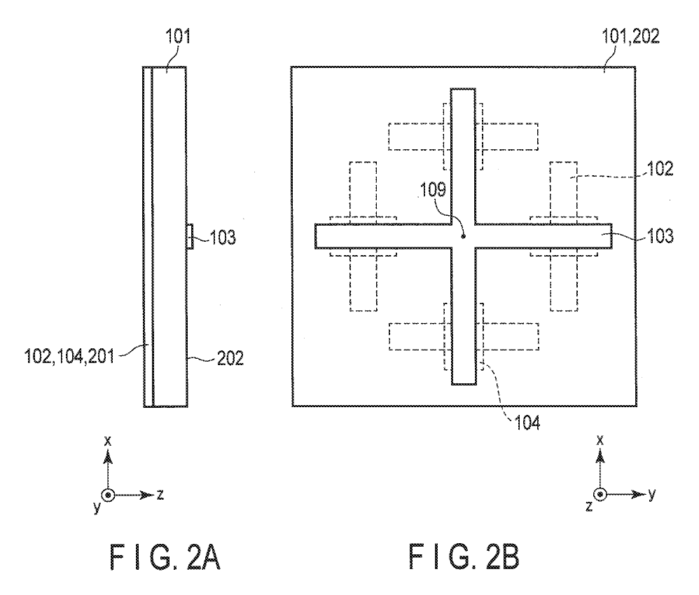

A side view of the antenna part 108 is shown in FIG. 2A, and a top view thereof is shown in FIG. 2B, which is viewed from a side of the second surface of the substrate 101.

As shown in FIG. 2A, the slot elements 102 are formed on the first surface 201 of the substrate 101, the switch

elements 104 are arranged on the first surface 201 of the substrate 101, and the power feed line 103 is arranged on the second surface 202 of the substrate 101.

As shown in FIG. 2B, the power feed line 103 is arranged on the second surface of the substrate 101. The power feed line 103 is cross-shaped and is supplied with power at an intersection part of the cross.

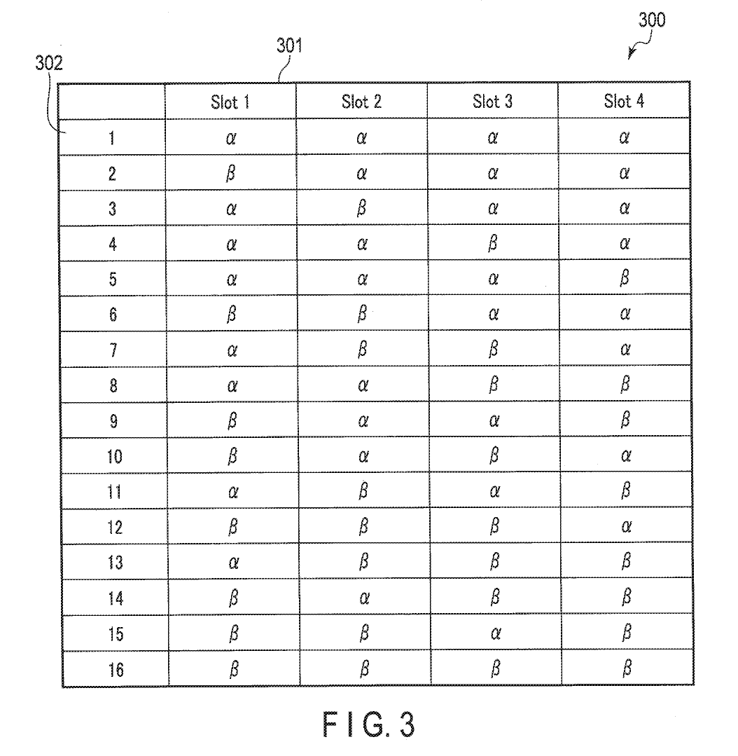

An example of radiation patterns of the antenna apparatus 100 according to the first embodiment will be described with reference to FIG. 3.

FIG. 3 shows a table 300, in which a slot number 301 that is an identification number of a slot element 102 is associated with a radiation pattern 302 determined by a phase difference of the slot elements 102.

When the switch element 104 short-circuits or opens the slot element 102 in the shorter direction (across the longer sides), the state of an electromagnetic field around the slot element 102 changes. Accordingly, a phase difference arises between a short-circuit state and an open state of the slot element 102. Therefore, radiation patterns can be changed by controlling phases of electromagnetic waves radiated from the slot elements 102.

The example shown in FIG. 3 is based on the assumption of the antenna part 108 including the four slot elements 102 shown in FIG. 1. The slot numbers 301 may be arbitrarily assigned to the four slot elements 102. A radio wave radiated from the antenna part 108 is a composite of radio waves radiated from the respective slot elements 102. Thus, since two different phases can be set for each of the slot elements 102, the number of radiation patterns 302 of the composite may be 2⁴=16 as shown in the table 300.

In FIG. 3, “α” denotes the phase of the open state of the slot element 102 and “β” denotes the phase of the short-circuit state of the slot element 102. For example, if all the slot elements 102 are open, the radiation pattern 302 is “1”. If slot 1 and slot 2 are open while slot 3 and slot 4 are short-circuited, the radiation pattern 302 is “8”. Thus, the antenna apparatus 100 of the first embodiment may have 2ⁿ radiation patterns, where n represents the number of slot elements.

In general, impedance matching is necessary in accordance with directivity of a set radiation pattern. Therefore, it is generally necessary to design an antenna in consideration of impedance matching that is the same in number as the radiation patterns. In the antenna apparatus 100 of the first embodiment, the slot elements 102 and the power feed line 103 are both rotationally symmetric about the first point as viewed in a z direction. Therefore, the number of radiation patterns, for which impedance matching should be taken into consideration, can be reduced.

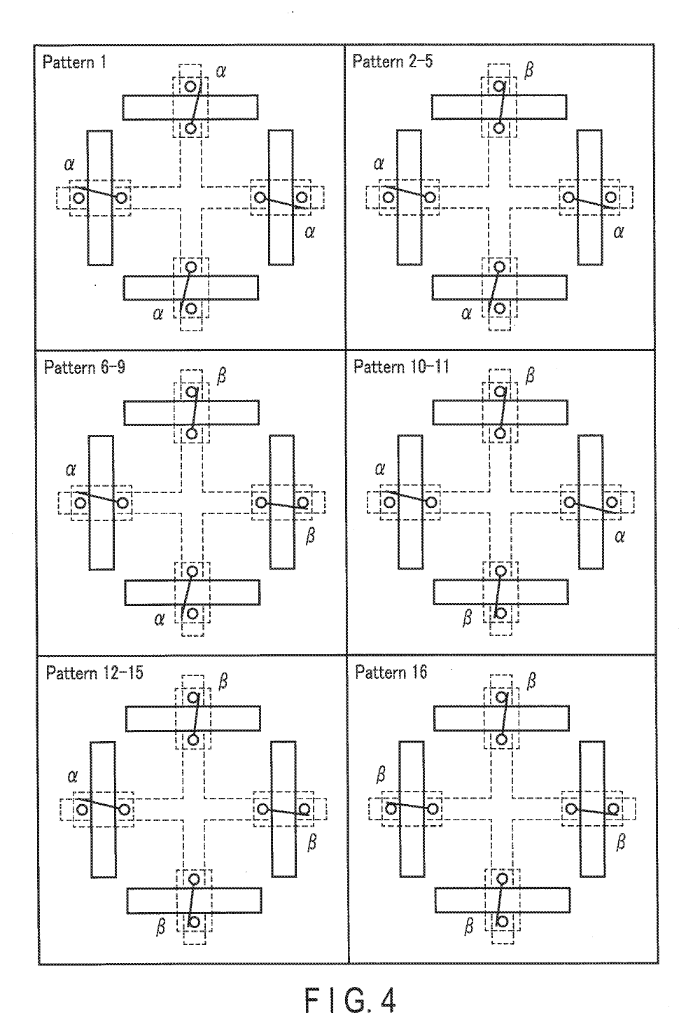

An example of the radiation patterns, for which impedance matching should be taken into consideration, will be described with reference to FIG. 4.

Of all radiation patterns shown in FIG. 3, the radiation patterns shown in FIG. 4 require impedance matching.

For example, assumed that one slot element is open (phase: α), while the other slot elements are short circuited (phase: β). In this case, the pattern in which only slot 1 is open (the radiation pattern 302 is “13”) and the pattern in which only slot 2 is open (radiation pattern 302 is “14”) are rotationally symmetric. Therefore, the same impedance matching is applicable to these patterns. Accordingly, the radiation patterns 302 of “12” to “15” are unified to a pattern at the bottom left of FIG. 4.

Thus, in consideration of the symmetry, impedance matching need not be taken into consideration for all of the 16 radiation patterns 302 of the example shown in FIG. 3; that is, impedance matching need be taken into consideration for only six radiation patterns. As a result, the antenna apparatus can be designed simply and efficiently.

Next, a first modification of the antenna part 108 will be described with reference to FIG. 5.

FIG. 5 is a perspective view of the antenna part 108 as viewed in the z direction from a side of the first surface 201 of the substrate 101. For convenience in explanation, the substrate 101 is omitted from FIG. 5.

In the example of FIG. 1, as described above, the power feed line 103 has a cross shape linearly extending to the four slot elements 102 from the first point 109 as a center of rotational symmetry. However, the power feed line 103 may be of any shape that is rotationally symmetric and extends to positions that are able to feed power to and excite the slot elements 102. For example, the power feed line 103 may have a complicated shape, for example, crossed “z” shapes as shown in FIG. 5.

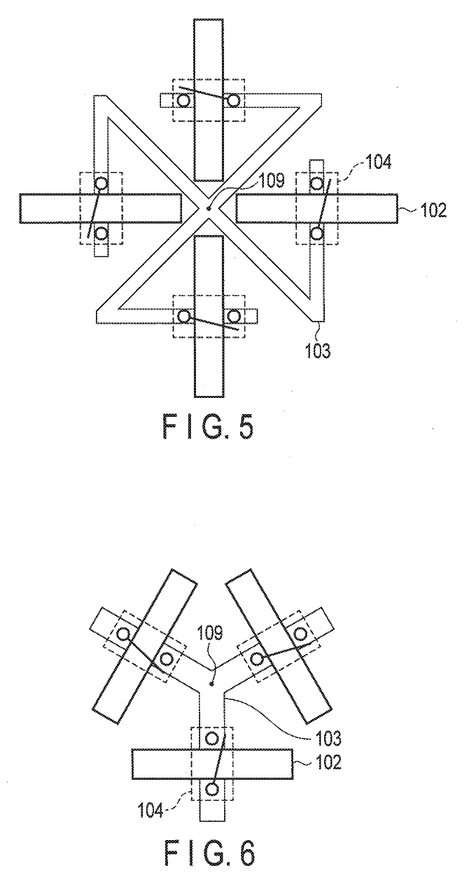

Next, a second modification of an arrangement of slot elements 102 will be described with reference to FIG. 6. FIG. 6, as well as FIG. 5, is a perspective view.

As shown in FIG. 6, the number of slot elements 102 is three, that is, not an even number but an odd number. In this case also, due to the power feed line 103 extending from the first point 109 as a center of rotational symmetry to the slot elements 102, the same effect as that of the configurations shown in FIG. 1 and FIG. 5 can be obtained.

According to the first embodiment described above, the switch elements are provided to open or short-circuit the respective slot elements. As a result, if the antenna part has n slot elements, as many as 2ⁿ radiation patterns can be set. In addition, the slot elements and the power feed line are both rotationally symmetric about the first point as viewed in a direction perpendicular to the substrate. As a result, the number of radiation patterns, for which impedance matching should be taken into consideration, can be reduced. Accordingly, the antenna apparatus can be designed easily with a simple configuration and a number of radiation patterns can be set.

### Second Embodiment

The second embodiment differs from the first embodiment in that a reflector plate is provided and a control line is rotationally symmetric as viewed in a direction perpendicular to a substrate.

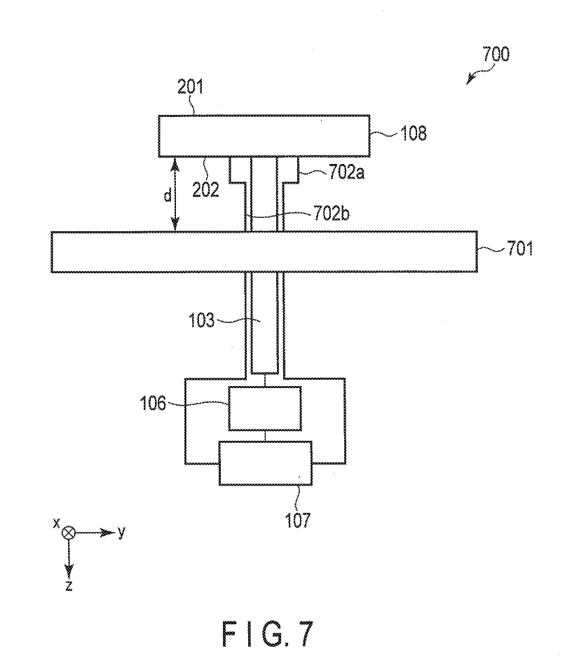

An antenna apparatus according to the second embodiment will be described with reference to FIG. 7.

The antenna apparatus 700 according to the second embodiment includes an antenna part 108, a reflector plate 701, control lines 702a and 702b (hereinafter also referred to as control lines 702), a wireless part 106, and a controller 107.

The antenna part 108, the wireless part 106, and the controller 107 are the same as those in the first embodiment, and descriptions thereof will be omitted.

A power feed line 103 is arranged on a second surface of a substrate 101 as in the first embodiment, and extends in a vertical direction (z direction) from a first point of the antenna part 108 about which slot elements 102 are rotationally symmetric.

The reflector plate 701 is made of a conductor. The reflector plate 701 is substantially parallel to the second surface 202 on which the power feed line 103 of the antenna part 108 is arranged, and located at a position opposite from a first surface 201 (in a z-axis direction in FIG. 7), and at a distance d within a half wavelength of the frequency in use.

The control lines 702 extend in the vertical direction (the z-axis direction) from the second surface 202 of the substrate 101 of the antenna part 108. The control lines 702 may operate as an antenna, and may interfere with radio waves radiated from the antenna part 108 and disturb the propagation status. If interference occurs, a directivity variable effect will be reduced, even if the radiation pattern of the antenna part 108 is changed.

To avoid reduction of the directivity variable effect, as shown in FIG. 7, the control lines 702 are concentrated near a central portion of the antenna part 108, and arranged to be rotationally symmetric as viewed in a direction perpendicular to the first surface 201 of the substrate 101 of the antenna part 108 (the z-axis direction). With this arrangement, even if the control lines 702 function as an antenna and radiate radio waves, it is expected that the radiated radio waves cancel each other. Since the control lines 702 exist in positions rotationally symmetric in any of the radiation patterns, radio waves that are not canceled are radiated rotationally symmetrically. Therefore, the directivity variable effect is not disturbed.

According to the second embodiment described above, the reflector plate is provided and the control lines are arranged to be rotationally symmetric. As a result, images of the slot elements can be formed as mirror images on the side opposite to the antenna part. Therefore, the direction of radiation of radio waves is limited, while the radio waves can be radiated on a half plane more efficiently as compared to a case of not using a reflector plate. Moreover, since the reflector plate blocks an influence upon the antenna part from the wireless part and the controller, the sensitivity to radio waves can be improved.

Thus, a large number of radiation patterns can be set with a simple configuration as well as the first embodiment. In addition, the directivity of the radio waves radiated from the antenna part can be controlled more robustly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scone and spirit of the inventions.

What is claimed is:

1. An antenna apparatus comprising:
a substrate including a first surface and a second surface that faces the first surface;
a plurality of slot elements provided on the first surface of the substrate;
a power feed line that is provided on the second surface of the substrate and feeds power to the slot elements; and
a plurality of switch elements that switch between a short-circuit state and an open state of the respective slot elements.

2. The antenna apparatus according to claim 1, wherein
the slot elements are arranged. to be rotationally symmetric about an axis perpendicular to the first surface; and
the power feed line is rotationally symmetric about the axis and extends from an intersection of the second surface with the axis to positions where the slot elements are fed.

3. The antenna apparatus according to claim 2, further comprising a control line used to control the switch elements, the control line being rotationally symmetric about the axis and extending in a direction opposite to the first surface from the second surface.

4. The antenna apparatus according to claim 1, further comprising:
a wireless part that acquires a propagation status of a wireless signal transmitted or received through the slot elements; and
a controller that controls, based on the propagation status, the switch elements to change a radiation pattern.

5. The antenna apparatus according to claim 1, further comprising a reflector plate comprising a conductor, the reflector plate being provided in parallel with the first surface and being located at a position opposite from the first surface and at a distance within a half wavelength of a frequency in use.

6. The antenna apparatus according to claim 1, wherein the switch elements are arranged on the first surface of the substrate.

7. The antenna apparatus according to claim 1, wherein the switch elements are arranged on the second surface of the substrate.

8. The antenna apparatus according to claim 1, wherein the switch elements are arranged on an interlayer of the substrate.
